(19) United States
(12) Patent Application Publication
(10) Pub. No.: US 2013/0223230 A1
(43) Pub. Date: Aug. 29, 2013

(54) Serving Multiple Subscribers Through a Software-Enabled Access Point

(71) Applicant: QUALCOMM INCORPORATED, (US)

(72) Inventors: Arvind Swaminathan, San Diego, CA (US); Srinivasan Balasubramanian, San Diego, CA (US); Rohit Tripathi, San Diego, CA (US)

(73) Assignee: QUALCOMM INCORPORATED, San Diego, CA (US)

(21) Appl. No.: 13/777,382

(22) Filed: Feb. 26, 2013

Related U.S. Application Data
(60) Provisional application No. 61/603,732, filed on Feb. 27, 2012.

(51) Int. Cl. H04W 76/02

(52) U.S. Cl. CPC H04W 76/02
USPC 370/241

(57) ABSTRACT

Methods and apparatus for serving multiple subscribers through a software-enabled access point (softAP) are described. One example method generally includes establishing at least one wireless wide area network (WWAN) connection for one or more wireless local area network (WLAN) clients, wherein each WLAN client belongs to one of a plurality of subscriber groups, and monitoring use of each WWAN connection for each subscriber group of the plurality of subscriber groups.

### CLAIM OF PRIORITY UNDER 35 U.S.C. §119

The present Application for Patent claims priority to U.S. Provisional Application Ser. No. 61/603,732, filed Feb. 27, 2012, entitled “SERVING MULTIPLE SUBSCRIBERS THROUGH A SOFTWARE-ENABLED ACCESS POINT,” herein incorporated by reference in its entirety.

### BACKGROUND

I. Field

The present disclosure generally relates to wireless communications and, more particularly, to techniques for identifying different groups of subscribers accessing a network through a single entity, such as a software-enabled access point (softAP).

II. Background

Wireless communication systems are widely deployed to provide various types of communication content such as voice, data, and so on. These systems may be multiple-access systems capable of supporting communications with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3rd Generation Partnership Project (3GPP) Long Term Evolution (LTE) systems and Orthogonal Frequency Division Multiple Access (OFDMA) systems.

Generally, a wireless multiple-access communication system can simultaneously support communications for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

One use of a wireless terminal is to send and receive data carried via a packet data network (PDN). Generally, an Access Point Name (APN) is used to identify a PDN for a mobile data user to communicate with. In addition to identifying the PDN, the APN may also be used to define the type of service. Examples of such connection-based services include a connection to a wireless application protocol (WAP) server, multimedia messaging services (MMS), or an internet protocol (IP) multimedia subsystem (IMS) service (e.g., voice over IP (VoIP), video telephony or text messaging) provided by a particular PDN. An APN is used in 3GPP data access networks, e.g. general packet radio service (GPRS), evolved packet core (EPC).

In some cases, a “multi-mode” wireless device may be capable of communicating via different radio access networks (RANs), such as a wireless wide area network (WWAN) and a wireless local area network (WLAN). With such capabilities, the device may be capable of connecting to the Internet over the WWAN and sharing the Internet connection with other wireless devices via the WLAN. In this case, the device may have software that allows it to act as an access point to serve the WLAN clients that share its WWAN Internet connection. For this reason, a wireless device with these capabilities is commonly referred to as a software-enabled access point (or simply a “softAP”) and such devices are often used to provide mobile “Hot spots.”

### SUMMARY

Certain aspects of the present disclosure provide a method for wireless communications. The method generally includes establishing at least one wireless wide area network (WWAN) connection for one or more wireless local area network (WLAN) clients, wherein each WLAN client belongs to one of a plurality of subscriber groups, and monitoring use of each WWAN connection for each subscriber group of the plurality of subscriber groups.

Certain aspects provide an apparatus for wireless communications. The apparatus generally includes means for establishing at least one WWAN connection for one or more WLAN clients, wherein each WLAN client belongs to one of a plurality of subscriber groups, and means for monitoring use of each WWAN connection for each subscriber group of the plurality of subscriber groups.

Certain aspects provide an apparatus for wireless communications. The apparatus generally includes at least one processor and a memory coupled to the at least one processor. The at least one processor is generally configured to establish at least one WWAN connection for one or more WLAN clients, wherein each WLAN client belongs to one of a plurality of subscriber groups, and monitor use of each WWAN connection for each subscriber group of the plurality of subscriber groups.

Certain aspects provide a computer-program product for wireless communications, comprising a computer-readable medium having instructions stored thereon, the instructions being executable by one or more processors. The instructions generally include instructions for establishing at least one WWAN connection for one or more WLAN clients, wherein each WLAN client belongs to one of a plurality of subscriber groups, and instructions for monitoring use of each WWAN connection for each subscriber group of the plurality of subscriber groups.

### BRIEF DESCRIPTION OF THE DRAWINGS

FIG. 1 illustrates a wireless communication network in which aspects of the present disclosure may be practiced.

FIG. 2 illustrates a block diagram of a user equipment (UE) and other network entities, in accordance with aspects of the present disclosure.

FIG. 3 illustrates an example softAP, in accordance with certain aspects of the present disclosure.

FIG. 4 illustrates example operations for wireless communications, in accordance with certain aspects of the present disclosure.

FIG. 5 illustrates example operations for establishing WWAN connections for different subscriber groups by using multiple access point names (APNs), in accordance with certain aspects of the present disclosure.

FIG. 6 illustrates example operations for establishing WWAN connections for different subscriber groups by using multiple packet data network (PDN) connections to the same APN, in accordance with certain aspects of the present disclosure.

FIG. 7 illustrates example operations for establishing WWAN connections for different subscriber groups based on differentiated services code point (DSCP) markings used in IP packets, in accordance with certain aspects of the present disclosure.

FIG. 8 illustrates example operations for establishing WWAN connections for different subscriber groups based on different bearers, in accordance with certain aspects of the present disclosure.

### DETAILED DESCRIPTION

As described above, a softAP can provide a group of WLAN clients access to the Internet over a WWAN connection. In some cases, network operators may require the ability to differentiate between the various connecting terminals and group them in order to properly bill for their usage.

Aspects of the present disclosure may enable softAPs to provide network operators with this ability to identify and differentiate between different subscriber groups. As a result, network operators gain the ability to charge each subscriber group for usage of all devices in that group.

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) can be practiced without these specific details. In other instances, well-known structures and devices are shown in block diagram form in order to facilitate describing one or more embodiments.

As used in this application, the terms “component,” “module,” “system,” and the like are intended to refer to computer-related entities such as: hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as, in accordance with a signal, having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, personal communications service (PCS) telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point, Node B, or evolved Node B (eNB)) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air-interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA 2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below. It should be noted that the descriptions are also applicable to other technologies with different terminologies.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects will be presented in terms of systems that can include a number of devices, components, modules, and the like. It is to be understood and appreciated that the various systems can include additional devices, components, modules, etc. and/or not include all of the devices, components, modules etc., discussed in connection with the figures. A combination of these approaches can also be used.

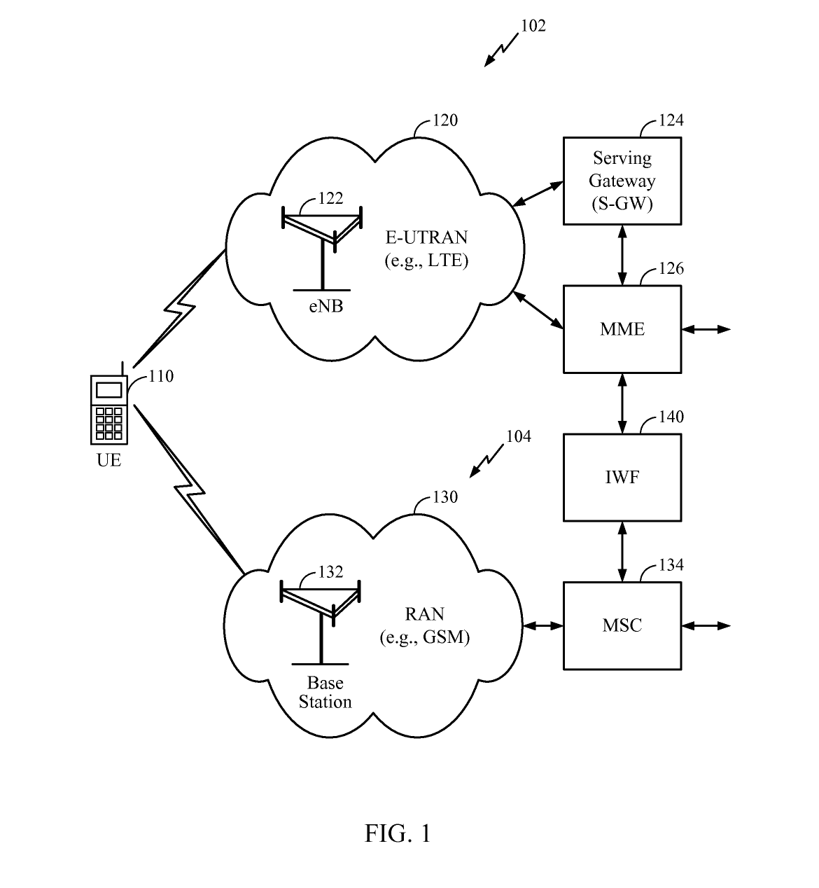

FIG. 1 shows an example environment in which aspects of the present disclosure may be practiced. As will be described in greater detail below, one or more devices, such as a User Equipment (UE) or other type of device, may act as a soft AP, providing one or more WLAN clients access to a WWAN, such as an evolved universal terrestrial radio access network (E-UTRAN) 120 and/or radio access network (RAN) 130. While the example shown in FIG. 1 depicts a UE capable of communicating with two WWANs, the techniques herein apply to any type of device capable of communicating with at least one WWAN.

E-UTRAN 120 may support LTE and may include a number of evolved Node Bs (eNBs) 122 and other network entities that can support wireless communication for user equipments 110 (UEs). Each eNB 122 may provide communication coverage for a particular geographic area. The term “cell” can refer to a coverage area of an eNB and/or an eNB subsystem serving this coverage area. A serving gateway (S-GW) 124 may communicate with E-UTRAN 120 and may perform various functions such as packet routing and forwarding, mobility anchoring, packet buffering, initiation of network-triggered services, etc. A mobility management entity (MME) 126 may communicate with E-UTRAN 120 and serving gateway 124 and may perform various functions such as mobility management, bearer management, distribution of paging messages, security control, authentication, gateway selection, etc. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

A radio access network (RAN) 130 may support GSM and may include a number of base stations 132 and other network entities that can support wireless communication for UEs. A mobile switching center (MSC) 134 may communicate with the RAN 130 and may support voice services, provide routing for circuit-switched calls, and perform mobility management for UEs located within the area served by MSC 134. Optionally, an inter-working function (IWF) 140 may facilitate communication between MME 126 and MSC 134 (e.g., for 1xCSFB).

E-UTRAN 120, serving gateway 124, and MME 126 may be part of an LTE network 102. RAN 130 and MSC 134 may be part of a GSM network 104. For simplicity, FIG. 1 shows only some network entities in the LTE network 102 and the GSM network 104. The LTE and GSM networks may also include other network entities that may support various functions and services.

In general, any number of wireless networks may be deployed in a given geographic area. Each wireless network may support a particular RAT and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs.

A UE 110 may be stationary or mobile and may also be referred to as a mobile station, a terminal, an access terminal, a subscriber unit, a station, etc. UE 110 may be a cellular phone, a personal digital assistant (PDA), a wireless modem, a wireless communication device, a handheld device, a laptop computer, a cordless phone, a wireless local loop (WLL) station, etc.

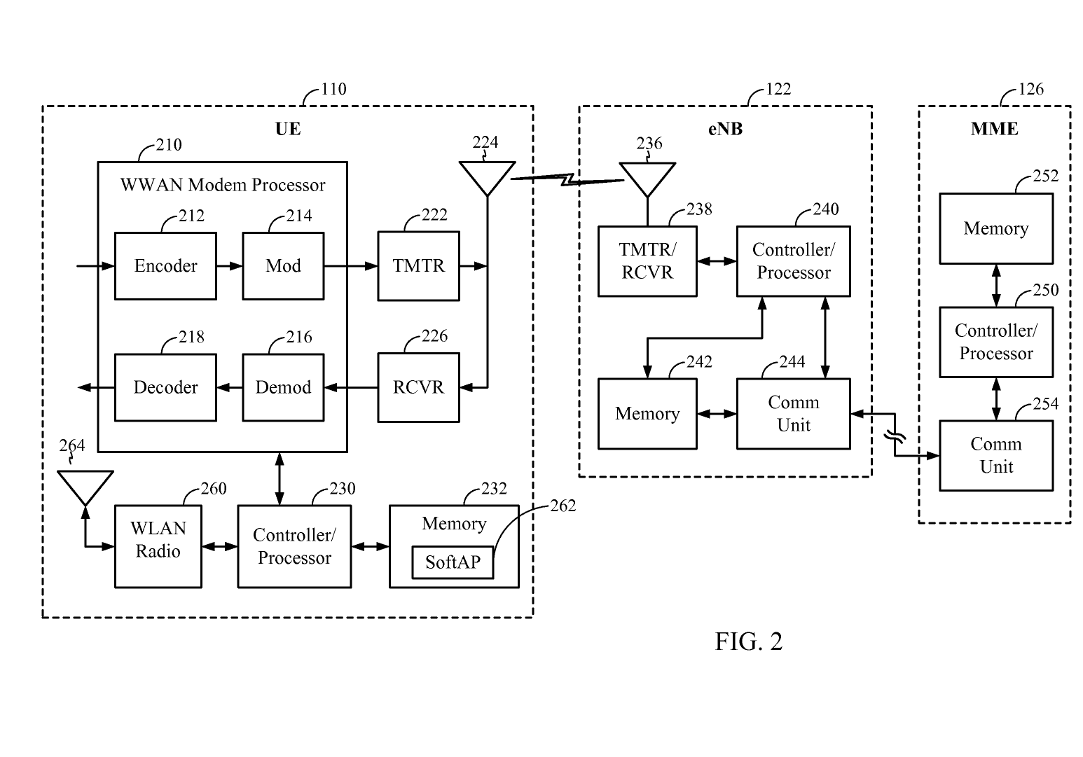

FIG. 2 shows a block diagram of a design of UE 110, eNB 122, and MME 126 in FIG. 1. At UE 110, an encoder 212 may receive traffic data and signaling messages to be sent on the uplink. Encoder 212 may process (e.g., format, encode, and interleave) the traffic data and signaling messages. A modulator (Mod) 214 may further process (e.g., symbol map and modulate) the encoded traffic data and signaling messages and provide output samples. A transmitter (TMTR) 222 may condition (e.g., convert to analog, filter, amplify, and frequency upconvert) the output samples and generate an uplink signal, which may be transmitted via an antenna 224 to eNB 122.

On the downlink, antenna 224 may receive downlink signals transmitted by eNB 122 and/or other eNBs/base stations. A receiver (RCVR) 226 may condition (e.g., filter, amplify, frequency downconvert, and digitize) the received signal from antenna 224 and provide input samples. A demodulator (Demod) 216 may process (e.g., demodulate) the input samples and provide symbol estimates. A decoder 218 may process (e.g., deinterleave and decode) the symbol estimates and provide decoded data and signaling messages sent to UE 110. Encoder 212, modulator 214, demodulator 216, and decoder 218 may be implemented by a modem processor 210. These units may perform processing in accordance with the RAT (e.g., LTE, 1xRTT, etc.) used by the wireless network with which UE 110 is in communication.

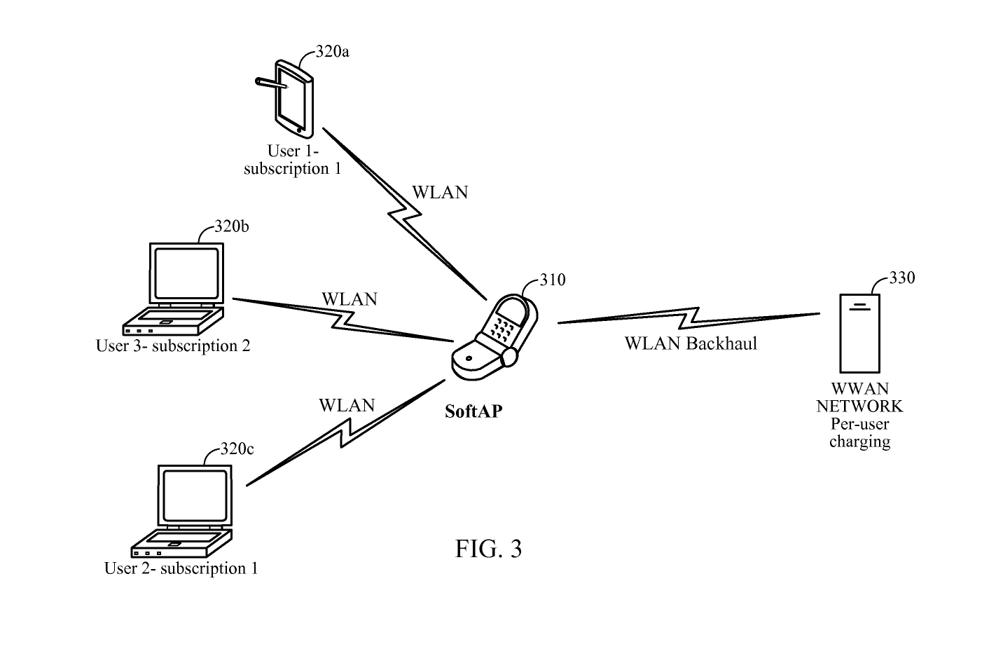

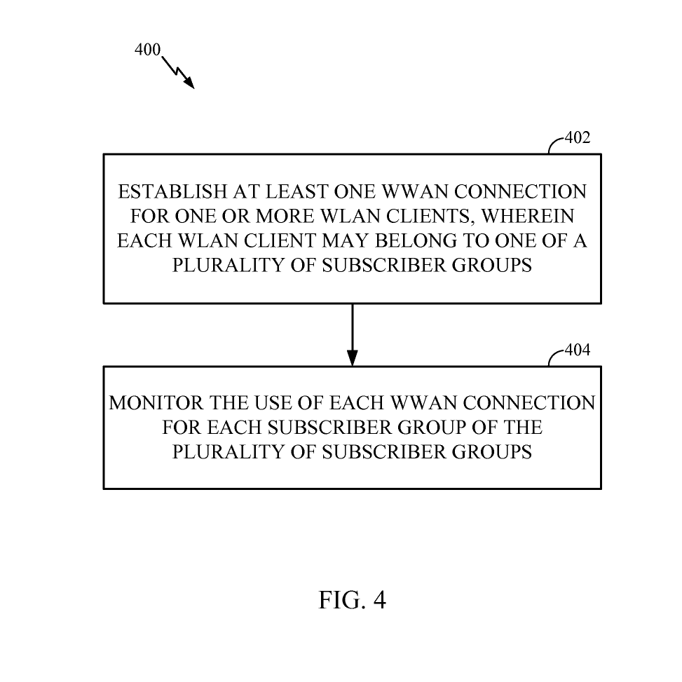

A controller/processor 230 may direct the operation at UE 110. Controller/processor 230 may also perform or direct other processes for the techniques described herein. Controller/processor 230 may also perform or direct the processing by UE 110 in FIGS. 3 and 4. Memory 232 may store program codes and data for UE 110. Memory 232 may also store a priority list and configuration information.

At eNB 122, a transmitter/receiver 238 may support radio communication with UE 110 and other UEs. A controller/processor 240 may perform various functions for communication with the UEs. On the uplink, the uplink signal from UE 110 may be received via an antenna 236, conditioned by receiver 238, and further processed by controller/processor 240 to recover the traffic data and signaling messages sent by UE 110. On the downlink, traffic data and signaling messages may be processed by controller/processor 240 and conditioned by transmitter 238 to generate a downlink signal, which may be transmitted via antenna 236 to UE 110 and other UEs. Controller/processor 240 may also perform or direct other processes for the techniques described herein. Controller/processor 240 may also perform or direct the processing by eNB 122 in FIGS. 3 and 4. Memory 242 may store program codes and data for the base station. A communication (Comm) unit 244 may support communication with MME 126 and/or other network entities.

At MME 126, a controller/processor 250 may perform various functions to support communication services for UEs. Controller/processor 250 may also perform or direct the processing by MME 126 in FIGS. 3 and 4. Memory 252 may store program codes and data for MME 126. A communication unit 254 may support communication with other network entities.

FIG. 2 shows simplified designs of UE 110, eNB 122, and MME 126. In general, each entity may include any number of transmitters, receivers, processors, controllers, memories, communication units, etc. Other network entities may also be implemented in similar manner.

As illustrated, UE 110 may also include circuitry (generally denoted as WLAN radio 260) to communication with a WLAN via one or more antennas 264. WLAN radio 260 may include circuitry similar to that described above for communicating via the WWAN (e.g., a WLAN modem processor, transmitter, and receiver). As described above, this may allow the UE 110 to act as a soft AP, sharing a WWAN connection among WLAN connections. For example, controller/processor 230 may execution instructions (shown as softAP 262) stored in memory 232 to perform softAP functions described in further detail below.

### Example of Serving Multiple Subscribers Through A Software-Enabled Access Point

As noted above, aspects of the present disclosure may allow a SoftAP to share a WWAN backhaul with multiple WLAN clients in a manner that allows the WWAN network operator to distinguish between different subscriber groups. Thus, network operators may gain the ability to differentiate between the various connecting clients and group them in order to bill for the usage of the network. This ability may be useful to network operators in a number of different scenarios.

As an example, internet connectivity provided by a WWAN may be shared by different apartments in an apartment complex or rooms in a hotel. Certain aspects of the present disclosure may provide the ability to distinguish the traffic coming from one set of WLAN clients (e.g., subscriber group 1 or simply “subscription 1”) from the traffic coming from a second set of WLAN clients (e.g., subscriber group 2 or simply “subscription 2”) and bill them separately.

As a second example, a train or bus may have a single WWAN backhaul that provides internet connectivity to multiple commuters. It may be useful to differentiate the traffic usage of the multiple commuters, particularly for billing purposes. In general, the techniques provided herein may be used in any market with less wireline infrastructure, where mobile hotspot solutions are used to provide the main means of internet connectivity.

FIG. 3 illustrates how, for certain aspects, a softAP may be used to share a WWAN backhaul among different users. A softAP 310 with wireless wide area network (WWAN) and wireless local area network (WLAN) interfaces may act as a WLAN AP and share a connection to a WWAN network 330 with other WLAN clients 320a, 320b, and 320c.

Among the different clients, one or more subscriber groups may exist, where it may be desirable for each subscriber group to be billed separately by the WWAN network operator. Each subscriber group may have one or more users, and the users within each group may be billed together. In the relatively simple example of FIG. 3, there are two subscriber groups, with Users 1 and 2 in subscription 1 and User 3 in subscription 2.

According to certain aspects of the present disclosure, the softAP 310 may be configured to establish and manage connections to the WWAN in a manner that allows for differentiating the traffic from the different subscriber groups. For example, the packet data network gateway (PGW)/high rate packet data (HRPD) serving gateway (HSGW) may differentiate the traffic from the different subscriptions. As examples, differentiating the traffic from the different subscriber groups may be used for billing the traffic separately and enforcing caps on traffic from each subscription.

FIG. 4 illustrates example operations 400 for differentiating traffic from different subscriber groups, in accordance with certain aspects of the present disclosure. The operations 400 may be performed, for example, by a wireless device, such as a UE 110 shown in FIG. 2, acting as a softAP. The operations may be performed, for example, by one or more of the WWAN Modem processor, controller/processor 230, and/or components in WLAN radio 260. In some cases, operations may be performed by the controller/processor executing instructions for a SoftAP 262 stored in memory 232.

At 402, the softAP may establish at least one WWAN connection for one or more WLAN clients, wherein each WLAN client may belong to one of a plurality of subscriber groups. At 404, the softAP may monitor the use of each WWAN connection for each subscriber group of the plurality of subscriber groups.

According to certain aspects, monitoring generally includes detecting traffic originating from a client that is a member of a subscriber group and forwarding that traffic in a manner that allows a network operator to identify and differentiate different subscriber groups for billing purposes.

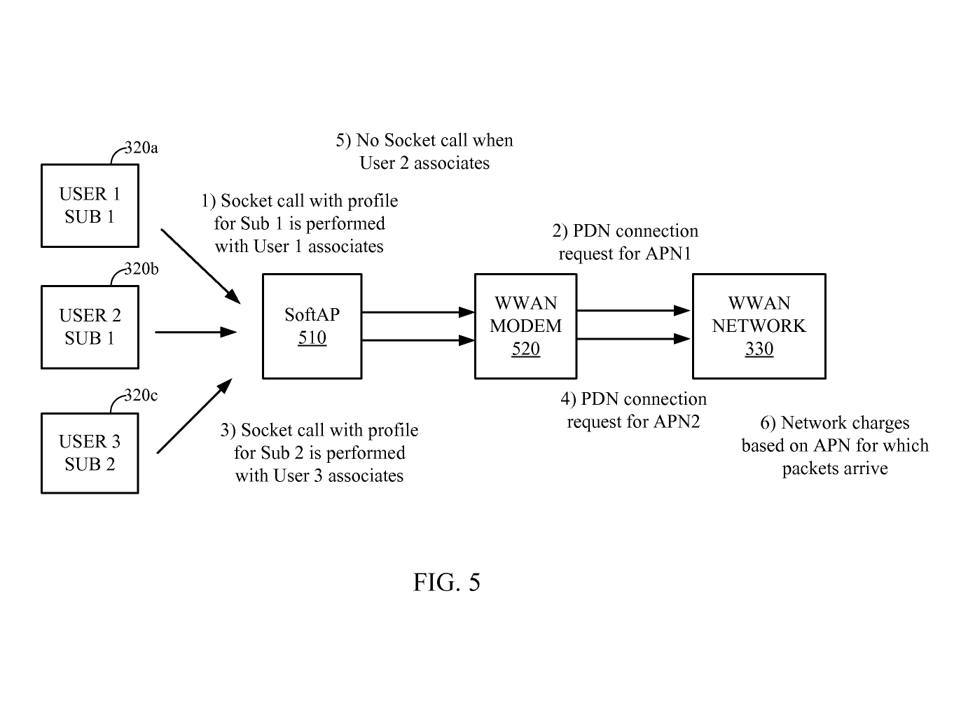

The present disclosure provides different mechanisms that allow for the identification and differentiation of different subscriber groups. Examples of these different mechanisms are described below, with reference to FIGS. 5-8.

According to certain aspects, establishing the WWAN connections generally includes using a different access point name (APN) for each subscriber group when establishing each WWAN connection. In other words, traffic from different subscriptions may be differentiated based on the APN used in a packet data network (PDN) connectivity request/vendor-specific network control protocol (VSNCP) configuration request used to get an Internet protocol (IP) address.

FIG. 5 illustrates an example approach that may allow a network operator to charge based on the APN for which packets arrive. In this case, the softAP 510 establishes WWAN connections for different subscriber groups by using multiple APN names.

According to certain aspects of the present disclosure, the network may have a mapping between a subscription X and an APN Y. When traffic is received at the network 330 from (or to) the IP address assigned to APN Y, subscription X may be billed.

Users with different subscriptions may be distinguished at a WLAN level (at 310) based on the service set identification (SSID) they connect over. A softAP may support multiple SSIDs and each subscription may be assigned one SSID. Another approach for distinguishing different subscriptions may include assigning a unique pre-shared key to each subscription. Different subscriptions may be distinguished at the WLAN level based on the pre-shared key used to associate with the AP. The WWAN modem 520 may have different application profiles and the softAP may have a mapping between the subscription and the profile to be used. The application profiles may contain different APN names.

When a user belonging to subscription X associates with the softAP, the softAP may check if other users with the same subscription have joined. If other users with the same subscription have not joined, the softAP may perform a socket call to generate a PDN connectivity request with the profile that corresponds to subscription X.

The IPv4 address and the IPv6 prefix/IID returned may be stored and associated with the profile/subscription. The IPv4 address returned may be used as the global address by the network address translation (NAT). The user may be assigned a local IP address and a NAT binding may be created that links this local IP address to the port and the external IP address associated with subscription. The prefix returned may be supplied to the user through a router advertisement (RA). The user's IP stack may perform duplicate address detection (DAD).

If other users with the same subscription have joined using their wireless terminal (e.g., User 2, subs 1), the softAP may perform a normal network address and port translation (NAPT) operation.

For IPv4, the softAP may assign a new local IP address and port number unused in the external IP address space. In other words, the softAP may create mapping between a local IP address assigned and port plus external IP address. For IPv6, the softAP may return the IPv6 prefix associated with the subscription through RA to the user. At the network side, all the APNs may get routed to the same PGW. However, the charging function may bill and enforce limits on maximum data usage on a per-APN level.

If a client belonging to subscription W uses his wireless terminal to associate with the softAP, the softAP may check if other users with the same subscription have joined. If other users with the same subscription have not joined, the softAP may perform a socket call to generate a PDN connectivity request with the profile that corresponds to subscription W.

In the example shown in FIG. 5, User 1 is the first of subscriber group 1 to join. Thus, a socket call is made, at (1), with a profile for subscriber group 1 to generate the PDN connectivity request, at (2) for APN1 associated with subscriber group 1. Similarly, User 3 is the first of subscriber group 2 to join, thus a socket call is made, at (3) with a profile for subscriber group 2 to generate a PDN connectivity request, at (4), for APN2 associated with subscriber group 2. On the other hand, when User 2 joins, the softAP determines that User 1 from the same group has already joined. Thus, no socket call is made, as indicated at (5). This approach allows the network operator to charge based on the APN for which packets arrive, as indicated at (6).

The IPv4 address and the IPv6 prefix/IID returned may be stored and associated with the profile/subscription. The IPv4 address returned may be used as the global address by the network address translation (NAT). The user may be assigned a local IP address and a NAT binding may be created that links this local IP address to the port and the external IP address associated with subscription. The prefix returned may be supplied to the user through a router advertisement (RA). The user's IP stack may perform duplicate address detection (DAD).

For certain aspects, establishing the WWAN connections generally includes using different authentication parameters during packet data network (PDN) level authentication for each subscriber group.

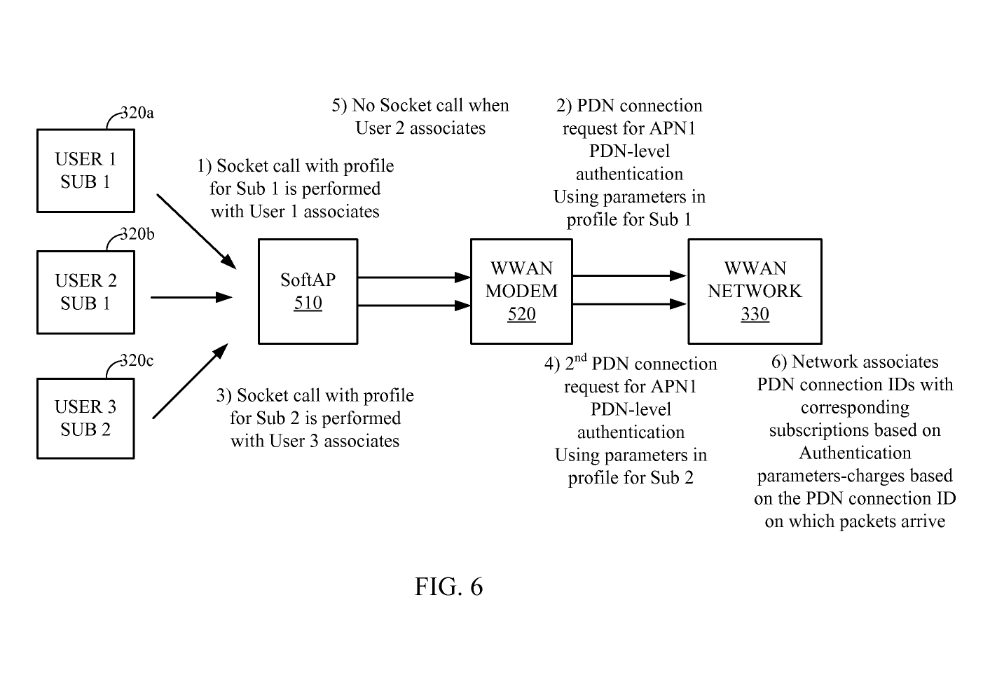

FIG. 6 illustrates example techniques for establishing WWAN connections for different subscriber groups by using multiple PDN connections to the same APN, in accordance with certain aspects of the present disclosure. Therefore, traffic from different subscriptions may be differentiated based on multiple PDN connections to the same APN. If a UE and network support a Re1-9 feature known as MUPSAP, that allows multiple PDN connections to the same APN, then this feature may be utilized. From a softAP perspective, procedures are similar as described above. For example, the softAP may have a mapping table that specifies which application profile to use for a given subscription. When a user belonging to subscription X uses his wireless terminal to associate with the softAP, the softAP may determine if another user from the same subscription has associated with the AP. If another user from the same subscription has associated with the AP (e.g., User 2, subs 1), the softAP may assign a new local IP address that is mapped. However, if other users with the same subscription have not used their wireless terminal to join (e.g., User 3, subs 2), the softAP may issue a new socket call to the WWAN modem with the correct user profile.

With regards to the approaches described above (i.e., multiple APN names and MUPSAP), the approaches may differ in the contents of the different application profiles. For multiple APN names, the profiles may have different APN names, as shown in FIG. 5. For MUPSAP, the profiles may have the same APN name but may specify that PDN level authentication needs to be used. The network may identify that a particular PDN connection is being established for a subscription X based on the authentication parameters being used during PDN level authentication. Since the WWAN UE and the network may support MUPSAP, multiple PDN connections may be established to the same APN, as shown in FIG. 6. Hence, when the softAP calls a new socket call with a different profile, MUPSAP may be used to connect to the same APN. When the PDN connection is established, the charging function may charge the correct subscription based on which authentication parameters were used during PDN level authentication.

In the example shown in FIG. 6, User 1 is again the first of subscriber group 1 to join, thus a socket call is made, at (1), with a profile for subscriber group 1 to generate the PDN connectivity request, at (2) for APN1 associated with subscriber group 1. In this example, PDN-level authentication is performed using authentication parameters in a profile for subscriber group 1. Similarly, User 3 is the first of subscriber group 2 to join, thus a socket call is made, at (3) with a profile for subscriber group 2 to generate a PDN connectivity request, at (4), for APN2 associated with subscriber group 2. In this case, PDN-level authentication is performed using authentication parameters in a profile for subscriber group 2. Again, when User 2 joins, the softAP determines that User 1 from the same group has already joined. Thus, no socket call is made, as indicated at (5). This approach allows the network operator to associate PDN connection IDs with corresponding subscription groups, based on authentication parameters, and charge based on the PDN connection ID for which packets arrive, as indicated at (6).

For certain aspects, establishing the WWAN connections generally includes marking Internet protocol (IP) packets with a different differentiated services code point (DSCP) marking for each subscriber group.

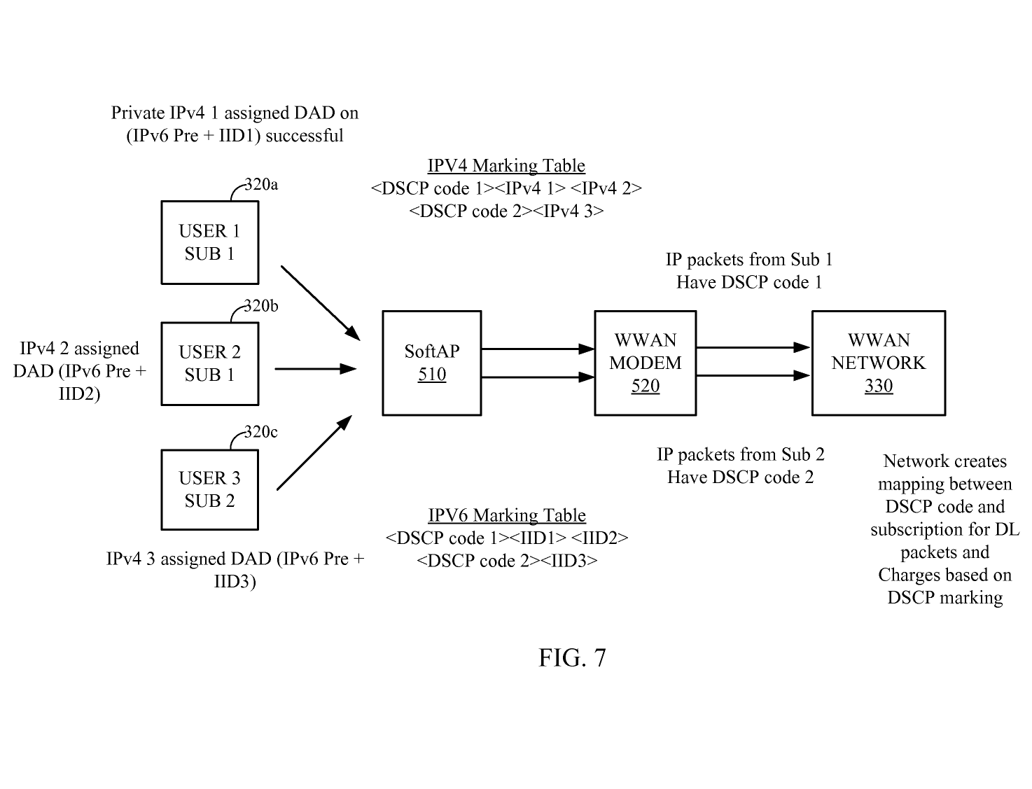

FIG. 7 illustrates example operations for establishing WWAN connections for different subscriber groups based on the DSCP markings used in IP packets, in accordance with certain aspects of the present disclosure. Therefore, the traffic from different subscriptions may be differentiated based on the DSCP markings used in the IP packets. Users with different subscriptions may be distinguished at the WLAN level through different pre-shared keys. For certain aspects, there may be a pre-arranged mapping between the subscription and the DSCP code. This may be known between the network and the softAP client.

When a user belonging to subscription X uses their wireless terminal to associate with the softAP, the NAT binding between the local IPv4 address assigned to the UE and the port number used in external packets may be enhanced to include the DSCP code corresponding to the subscription.

As shown in FIG. 7, a first marking table may indicate a mapping between assigned DSCP codes and the local IPv4 addresses is maintained by the softAP 310. As indicated at (1a)-(1c), users in subscription group 1 (User 1 and User 2) may be assigned addresses IPv4 1 and IPv4 2 for IPv4 communications, while the user in subscription group 2 (User 3) is assigned address IPv4 3. Similarly, users in subscription group 1 may be assigned IID1 or IID2 for IPv6 communications, while the user in subscription group 2 (User 3) is assigned IID3.

As indicated at (4), all outgoing packets from the local IP address may be marked with the corresponding DSCP code when they pass through NAT, as indicated at (2) and (3). When the user performs DAD for IPv6, a mapping may be associated between the IPv6 address and the DSCP code corresponding to the subscription. Outgoing IPv6 packets may need to be modified to include the corresponding DSCP code.

As indicated, at network 330, charging may be based on this DSCP marking. To accomplish this, the charging function in the network may need to account for the DSCP code in the UL packets while charging. In order to charge the DL packets correctly, when the charging function sees an UL packet with a certain DSCP code, the charging function may create the following mapping:

<DSCP - code, source IP address in UL packet, source port in UL
packet, destination IP address in UL packet, destination port in UL
packet>

Subsequently, for IPv6, the charging function may charge DL packets that arrive with the destination IP equal to the source IP address in the mapping table. For IPv4, the charging function may charge DL packets that arrive with the destination port equal to the source port in the mapping table, the source IP equal to the destination IP address in the mapping table, and the source port equal to the destination port in the mapping table.

According to certain aspects, network charging may be based on a dedicated bearer on which packets arrive.

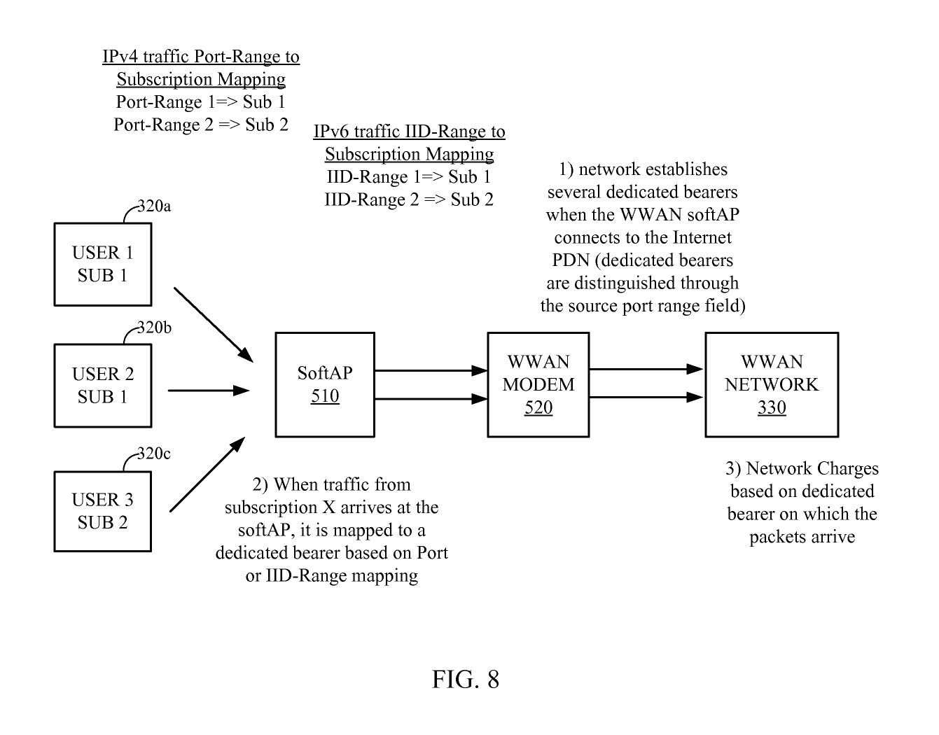

FIG. 8 illustrates example operations for establishing WWAN connections for different subscriber groups based on mapping traffic from each subscriber group to different dedicated bearers, in accordance with certain aspects of the present disclosure. In this approach, the network may establish several dedicated bearers when the SoftAP connects to the Internet, at (1). The dedicated bearers may be distinguished through a source port range field. When traffic arrives from a particular subscriber group, at (2), the softAP maps the traffic to a dedicated bearer base on a port range mapping (for IPv4) or IID range mapping (for IPv6). As a result, at network 330, charging may be based on the dedicated bearers on which packets arrive, at (3).

In order to map traffic from different subscriptions to different dedicated bearers, a mechanism may be required for the network to know the mapping between the dedicated bearer and the subscription. This may be achieved for IPv4 traffic by a pre-arranged mapping between the port-range and the subscription, as shown in the Port-Range to Subscription Mapping in FIG. 8. For example, the network may establish several dedicated bearers when the WWAN softAP connects to the Internet PDN, at (1). For certain aspects, the dedicated bearers may be distinguished through the source port range field. When traffic from subscription X arrives at the softAP, the external port selected by the NAPT may belong to the port-range assigned to subscription X. Thus, this traffic may get routed over the appropriate dedicated bearer. The billing function in the network may use the dedicated bearer on which the packets arrive to bill each family differently.

For IPv6 traffic, a pre-arranged mapping between IID range and subscription, as shown in the IID-Range to Subscription Mapping in FIG. 8, may be required. For example, the network may establish several dedicated bearers when the WWAN softAP connects to the Internet PDN. The dedicated bearers may be distinguished through the IID value in the source IP field (e.g., in Rel-10). When a user from subscription X associates with the softAP, the IPv6 address may be forced to have an IID in the range associated with subscription X. The softAP solution may use the DAD to enforce the IID range. In other words, when a user from subscription X performs a DAD, the DAD may fail unless the IID chosen belongs to the range. When traffic from subscription X arrives at the softAP, the traffic may get routed over the appropriate dedicated bearer because of the IID in the packet. The billing function in the network may use the dedicated bearer on which the packets arrive to distinguish one subscription from another.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications, comprising:
establishing at least one wireless wide area network (WWAN) connection for one or more wireless local area network (WLAN) clients, wherein each WLAN client belongs to one of a plurality of subscriber groups; and
monitoring use of each WWAN connection for each subscriber group of the plurality of subscriber groups.

2. The method of claim 1, wherein the monitoring comprises differentiating the use of each WWAN connection for each subscriber group of the plurality of subscriber groups.

3. The method of claim 2, wherein the differentiating comprises assigning a different pre-shared key to each subscriber group.

4. The method of claim 2, wherein the differentiating comprises assigning a different service set identification (SSID) to each subscriber group.

5. The method of claim 1, wherein the establishing comprises using a different access point name (APN) for each subscriber group when establishing each WWAN connection.

6. The method of claim 1, wherein the establishing comprises using different authentication parameters during packet data network (PDN) level authentication for each subscriber group.

7. The method of claim 1, wherein the establishing comprises marking Internet protocol (IP) packets with a different differentiated services code point (DSCP) marking for each subscriber group.

8. The method of claim 7, wherein the different DSCP marking for each subscriber group is pre-arranged with a network.

9. The method of claim 1, wherein the establishing comprises mapping traffic from each subscriber group to different dedicated bearers.

10. The method of claim 9, wherein the mapping to the different dedicated bearers is pre-arranged with a network.

11. An apparatus for wireless communications, comprising:
means for establishing at least one wireless wide area network (WWAN) connection for one or more wireless local area network (WLAN) clients, wherein each WLAN client belongs to one of a plurality of subscriber groups; and
means for monitoring use of each WWAN connection for each subscriber group of the plurality of subscriber groups.

12. The apparatus of claim 11, wherein the means for monitoring comprises means for differentiating the use of each WWAN connection for each subscriber group of the plurality of subscriber groups.

13. The apparatus of claim 12, wherein the means for differentiating comprises means for assigning a different pre-shared key to each subscriber group.

14. The apparatus of claim 12, wherein the means for differentiating comprises means for assigning a different service set identification (SSID) to each subscriber group.

15. The apparatus of claim 11, wherein the means for establishing comprises means for using a different access point name (APN) for each subscriber group when establishing each WWAN connection.

16. The apparatus of claim 11, wherein the means for establishing comprises means for using different authentication parameters during packet data network (PDN) level authentication for each subscriber group.

17. The apparatus of claim 11, wherein the means for establishing comprises means for marking Internet protocol (IP) packets with a different differentiated services code point (DSCP) marking for each subscriber group.

18. The apparatus of claim 17, wherein the different DSCP marking for each subscriber group is pre-arranged with a network.

19. The apparatus of claim 11, wherein the means for establishing comprises means for mapping traffic from each subscriber group to different dedicated bearers.

20. The apparatus of claim 19, wherein the means for mapping to the different dedicated bearers is pre-arranged with a network.

21. An apparatus for wireless communications, comprising:
at least one processor configured to:
establish at least one wireless wide area network (WWAN) connection for one or more wireless local area network (WLAN) clients, wherein each WLAN client belongs to one of a plurality of subscriber groups; and
monitor use of each WWAN connection for each subscriber group of the plurality of subscriber groups; and
a memory coupled to the at least one processor.

22. A computer-program product for wireless communications, comprising a non-transitory computer-readable medium having instructions stored thereon, the instructions being executable by one or more processors and the instructions comprising:
instructions for establishing at least one wireless wide area network (WWAN) connection for one or more wireless local area network (WLAN) clients, wherein each WLAN client belongs to one of a plurality of subscriber groups; and
instructions for monitoring use of each WWAN connection for each subscriber group of the plurality of subscriber groups.
